(19) United States
(12) Patent Application Publication
(10) Pub. No.: US 2008/0016741 A1
(43) Pub. Date: Jan. 24, 2008

(54) Display panel

(76) Inventor: Tong-Hsin Cheng, Taipei City (TW)

Correspondence Address: Troxell Law Office Pllc, Suite 1404, 5205 Leesburg Pike, Falls Church, VA, 22041, US

(21) Appl. No.: 11/488,699

(22) Filed: Jul. 19, 2006

(51) Int. Cl. G09F 3/18

(52) U.S. Cl. 40/661

(57) ABSTRACT

A display panel of the present invention basically includes a transparent panel and at least one sticking pad. A gap that extends within the transparent panel is defined at one end of the transparent panel, and the gap enables a photograph or other graph card to be inserted into the transparent panel. The sticking pad is at least bonded to a rear surface of the transparent panel. Accordingly, the display panel enables the transparent panel to be adhered to a wall or display cabinet using the sticking pad, and provides optimum visual display and exposure of the photograph or graph card within the transparent panel. More particularly, the display panel can be adhered repeatedly in different positions an unlimited number of times, thereby substantially characterizing practicability and convenience of use of the entire display panel.

### BACKGROUND OF THE INVENTION

(a) Field of the Invention

The present invention relates to a photograph or graph card display structure, and more particularly to a display panel structure which enables presenting a photograph or graph card inserted within a transparent panel with optimum visual display and exposure effectiveness by means of a simple sticking action.

(b) Description of the Prior Art

In daily life, it is common for people to frequently place their favorite photographs on an office desk, a study desk or furniture, with the objective of being able to cherish the scene within the photograph anytime. However, the majority of common photographs are less than 0.1 centimeters in thickness, and are thus unable to stand upright on their own. Hence, the photograph must be placed within a display support similar to a photo frame, thereby enabling the photograph to be displayed in an upright position on top of an office desk, a study desk or furniture by means of the structural form of the photo frame.

Referring to FIG. 1, which shows a photo frame structure of prior art, wherein a photo frame 10 has a structural form including an insertion slot 11 and a base 12 produced by direct folding or bonding of transparent acrylic material,. thereby enabling a photograph 20 to be inserted within the photo frame 10 through the insertion slot 11, and achieving displaying the photograph 20 in an upright position by means of the supporting function of the base 12. Moreover, the insertion slot 11 similarly enables insertion of a catalog, nameplate, graph card, and so on, thus, the structural form is not restricted to being only used as a photo frame, but can also be functionally extended to serve as a tabletop price list or a tabletop advertisement display stand.

However, tabletop photo frames similar to that depicted in FIG. 1 can only be used to display a photograph or graph card in an upright position on a tabletop. Another prior art includes a wall-type photo frame, and although such a photo frame structure enables hanging a photograph or graph card on a wall for display thereof, however, a suspension hook must be fitted to the wall prior to hanging the photo frame, which is extremely inconvenient in use, and does not allow display position of the photograph to be arbitrarily changed.

### SUMMARY OF THE INVENTION

In light of the aforementioned, the present invention provides a display panel structure which enables presenting a photograph or graph card inserted within a transparent panel with optimum visual display and exposure effectiveness by means of a simple sticking action. Moreover, position of the display panel can be changed an unlimited number of times by means of a sticking pad.

A display panel of the present invention is primarily structured to comprise a transparent panel and at least one sticking pad. A gap that extends within the transparent panel is defined at one end of the transparent panel, and the gap enables a photograph or other graph card to be inserted into the transparent panel. The sticking pad is at least bonded to a rear surface of the transparent panel.

Accordingly, the display panel enables the transparent panel to be adhered to a wall or display cabinet using the sticking pad, and provides optimum visual display and exposure of the photograph or graph card within the transparent panel. More particularly, the display panel can be adhered repeatedly in different positions an unlimited number of times, thereby substantially characterizing practicability and convenience of use of the entire display panel.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

FIG. 2 shows an exterior elevational view of a display panel according to the present invention.

FIG. 3 shows a structural cutaway view of the display panel according to the present invention.

FIG. 4 shows a state diagram of the display panel bonded to a wall according to the present invention.

FIG. 5 shows a state diagram of the display panel disposed on a tabletop in an upright position according to the present invention.

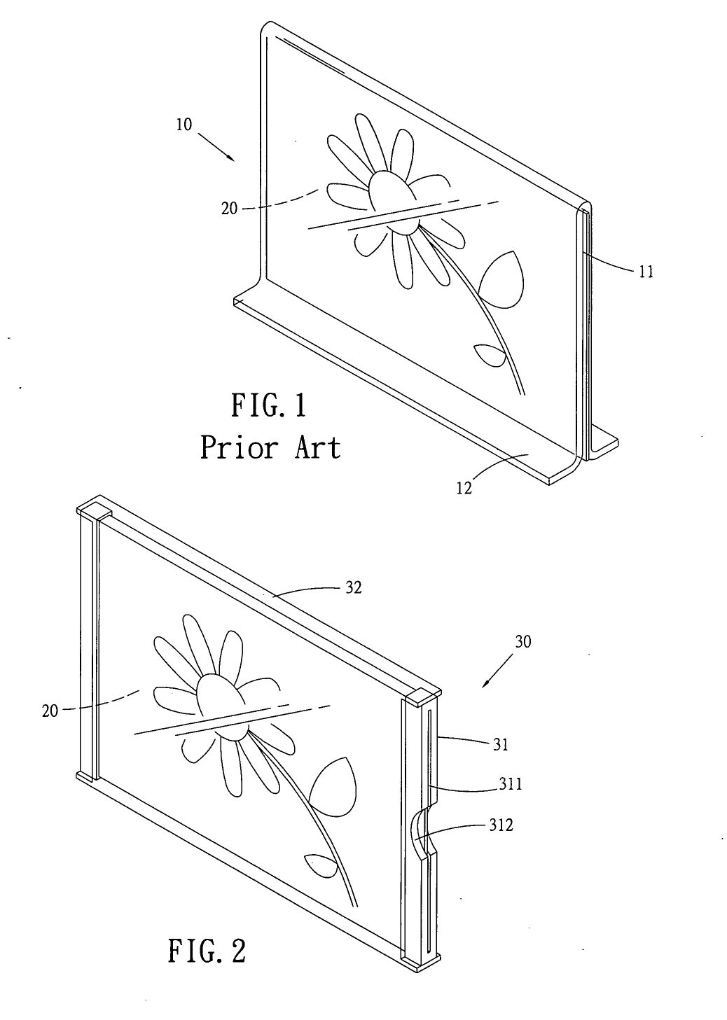

### DETAILED DESCRIPTION OF THE PREFERRED EMBODIMENTS

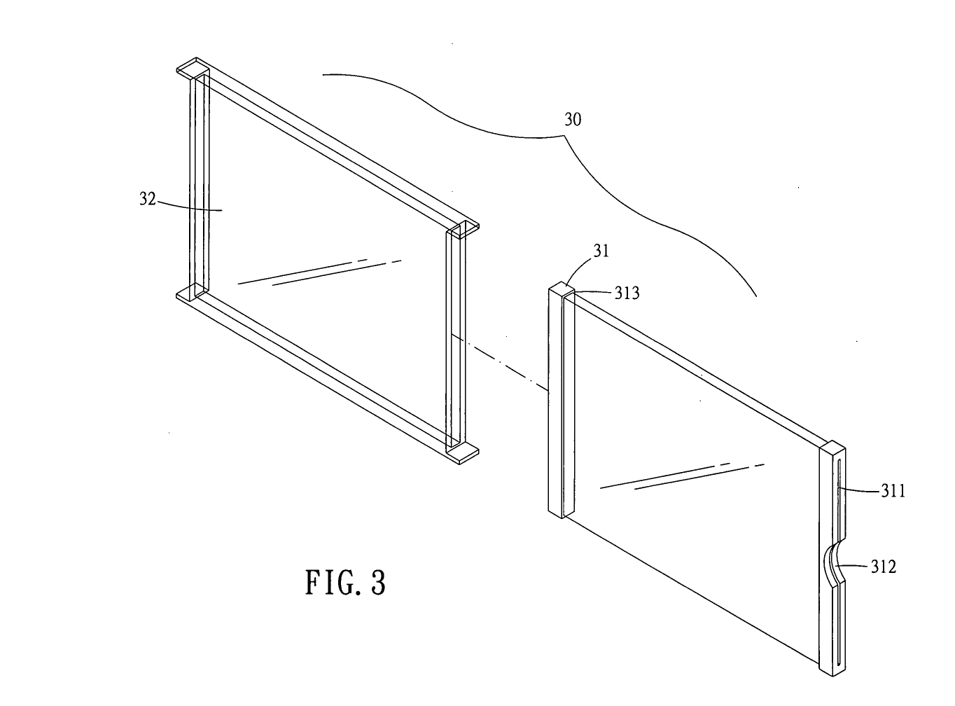

A display panel of the present invention provides a display panel structure that enables presenting a photograph or graph card inserted within a transparent panel with optimum visual display and exposure effectiveness by means of a simple sticking action. Moreover, position of the display panel can be changed an unlimited number of times by means of a sticking pad. Referring to FIG. 2 and FIG. 3, which show a display panel 30 of the present invention primarily structured to comprise a transparent panel 31 and at least one sticking pad 32. A gap 311 that extends within the transparent panel 31 is defined at one end of the transparent panel 31. The gap 311 enables a photograph 20 or other graph card, such as a catalog or a nameplate, to be inserted into the transparent panel 31, and a notch 312 that enables fingers to conveniently grasp the photograph 20 is defined at an end portion of the transparent panel 31 at an opening of the gap 311.

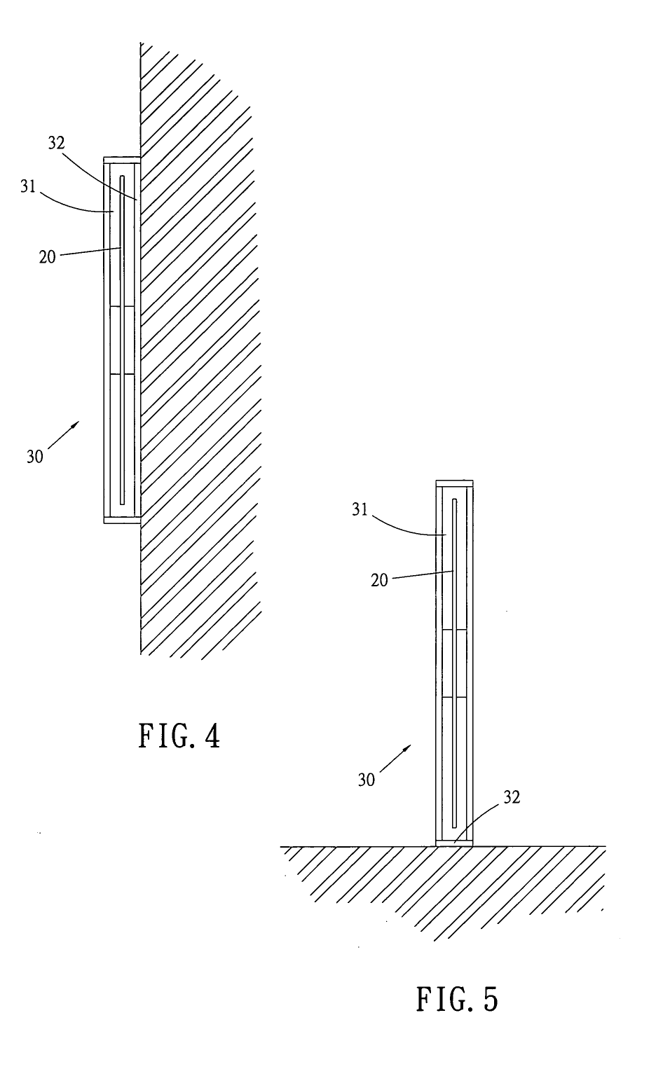

The sticking pad 32 is at a minimum bonded to a rear surface of the transparent panel 31, while in actual use, the sticking pad 32 can also be a transparent sticking pad which covers a front surface, rear surface, top surface and bottom surface of the transparent panel 31. Steps 313 are located on the transparent panel 31, which function in coordination with corresponding covering portions of the sticking pad 32, thereby increasing the binding effect between the sticking pad 32 and the transparent panel 31, and enabling the entire transparent panel 31 to be adhered to a wall or display cabinet using the sticking pad 32 located on the rear surface, as depicted in FIG. 4, thus visually displaying and exposing the photograph 20 or a graph card within the transparent panel 31 on a wall or display cabinet by adhering means.

Referring to FIG. 5, of course, the sticking pad 32 can also be located on a bottom surface of the transparent panel 31, thereby enabling the transparent panel 31 to be adhered to the top of an office desk, a study desk or other furniture, and enabling the photograph 20 or a graph card within the transparent panel 31 to be displayed on the top of an office desk, a study desk or other furniture in an upright position. Hence, the display panel 30 of the present invention enables presenting a photograph or graph card inserted within the transparent panel 31 with optimum visual display and exposure effectiveness by means of a simple sticking action. Moreover, position of the display panel 30 can be changed an unlimited number of times by means of the sticking pad 32, thereby substantially characterizing practicability and convenience of use of the entire display panel.

According to the aforementioned, the present invention provides an improved practicable display panel structure, and clearly complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A display panel comprising a transparent panel, a gap is defined at an end of the transparent panel that enables a photograph or graph card to be inserted therein, and a sticking pad which is at least bonded to a rear surface of the transparent panel.

2. The display panel according to claim 1, wherein the sticking pad is a transparent sticking pad covering a front surface, the rear surface, a top surface and a bottom surface of the transparent panel.

3. The display panel according to claim 1, wherein steps are located on the transparent panel corresponding to covering portions of the sticking pad.

4. The display panel according to claim 2, wherein steps are located on the transparent panel corresponding to covering portions of the sticking pad.

5. The display panel according to claim 1, wherein a notch that enables fingers to conveniently grasp a photograph is defined at an end portion of the transparent panel at an opening of the gap.
